(19) United States
(12) Patent Application Publication
(10) Pub. No.: US 2011/0098042 A1
(43) Pub. Date: Apr. 28, 2011

(54) Apparatus and Method for Deriving Idle Mode Parameters for Cell Selection/Reselection

(76) Inventors: Tomasz Mach, Fleet (GB); Christopher Peter Callender, Fleet (GB)

(21) Appl. No.: 12/604,191

(22) Filed: Oct. 22, 2009

(51) Int. Cl. H04W 8/02

(52) U.S. Cl. 455/435.1

(57) ABSTRACT

An apparatus, system and method for deriving idle mode parameters for cell selection/reselection in a communication system. In one embodiment, the apparatus includes a measurement manager configured to provide an event sequence estimating communication channel performance between a user equipment operable in an active mode emulating an idle mode and at least one of a serving base station and a target base station. The apparatus also includes a cell selection/reselection subsystem configured to select/reselect the target base station for the user equipment operable in the idle mode employing an idle mode parameter derived from a plurality of event sequences at the serving base station.

### TECHNICAL FIELD

The present invention is directed, in general, to communication systems and, in particular, to an apparatus, system and method for deriving idle mode parameters for cell selection/reselection in a communication system.

### BACKGROUND

Long Term Evolution (“LTE”) of the Third Generation Partnership Project (“3GPP”), also referred to as 3GPP LTE, refers to research and development involving the 3GPP Release 8 and beyond, which is the name generally used to describe an ongoing effort across the industry aimed at identifying technologies and capabilities that can improve systems such as the universal mobile telecommunication system (“UMTS”). The goals of this broadly based project include improving communication efficiency, lowering costs, improving services, making use of new spectrum opportunities, and achieving better integration with other open standards. The 3GPP LTE project is not itself a standard-generating effort, but will result in new recommendations for standards for the UMTS. Further developments in these areas are also referred to as Long Term Evolution-Advanced (“LTE-A”).

The evolved UMTS terrestrial radio access network (“E-UTRAN”) in 3GPP includes base stations providing user plane (including packet data convergence protocol/radio link control/medium access control/physical (“PDCP/RLC/MAC/PHY”) sublayers) and control plane (including radio resource control (“RRC”) sublayer) protocol terminations towards wireless communication devices such as cellular telephones. A wireless communication device or terminal is generally known as user equipment (“UE”) or a mobile station (“MS”). A base station is an entity of a communication network often referred to as a Node B or an NB. Particularly in the E-UTRAN, an “evolved” base station is referred to as an eNodeB or an eNB. For details about the overall architecture of the E-UTRAN, see 3GPP Technical Specification (“TS”) 36.300, v8.5.0 (2008-05), which is incorporated herein by reference. The terms base station, NB, eNB, and cell refer generally to equipment providing the wireless-network interface in a cellular telephone system, and will be used interchangeably herein, and include cellular telephone systems other than those designed under 3GPP standards.

One of the continuing problems in LTE and UMTS communication systems is setting the initial configuration of network parameters and the continued adjustment thereof based on data transmitted to base stations by user equipment in an active mode. The network parameters, which are broadcast by the network to user equipment, control actions employed by the user equipment in an idle mode, such as idle mode cell selection/reselection thresholds, and directly affect battery drains of the user equipment as well as communication metrics related to quality of service. In currently deployed networks (e.g., networks based on UTRAN technology), a mobile operator expends a significant amount of effort to adjust and maintain the settings for the network parameters. This effort is encumbered by increasing network complexity, rendering the procedure to set the network parameters as time consuming and necessitating a substantial amount of manual input. As a result, the 3GPP has introduced a self-organizing/optimizing network (“SON”) concept for LTE-based communication systems as described in the 3GPP Technical Report 36.902 entitled “Evolved Universal Terrestrial Radio Access Network (E-UTRAN); Self-Configuring and Self-Optimizing Network Use Cases and Solutions,” Release 9, May 2009, and in 3GPP TS 32.521, entitled “Telecommunications Management; Self-Optimization OAM; Concepts and Requirements,” Release 9, July 2009, which are incorporated herein by reference.

The SON concept describes use cases to support automatic radio access network (“RAN”) configuration and optimization. Enhancements are needed to active mode user equipment measurement events, especially as the events relate to finding improved values for cell selection/reselection parameters employed by the user equipment in an idle mode.

In view of the growing deployment and sensitivity of users to communication performance in cellular networks, further improvements are necessary for adjusting network parameters for cell selection/reselection. Therefore, what is needed in the art is a system and method that avoid the associated deficiencies of conventional networks in accordance with providing a user equipment with adjusted parameters to provide improved battery life without compromising other user equipment characteristics such as quality of service.

### SUMMARY OF THE INVENTION

These and other problems are generally solved or circumvented, and technical advantages are generally achieved, by embodiments of the present invention, which include an apparatus, system and method for deriving idle mode parameters for cell selection/reselection in a communication system. In one embodiment, the apparatus (e.g., a processor of a user equipment) includes a measurement manager configured to provide an event sequence estimating communication channel performance between a user equipment operable in an active mode emulating an idle mode and at least one of a serving base station and a target base station. The apparatus also includes a cell selection/reselection subsystem configured to select/reselect the target base station for the user equipment operable in the idle mode employing an idle mode parameter derived from a plurality of event sequences at the serving base station.

In another embodiment, an apparatus (e.g., a processor of a base station) includes an event accumulator configured to receive a plurality of event sequences estimating communication channel performance from a plurality of user equipment operable in an active mode emulating an idle mode with at least one of a serving base station and a target base station. The apparatus also includes a cell selection/reselection parameter subsystem configured to derive an idle mode parameter for cell selection/reselection by the plurality of user equipment operable in the idle mode as a function of the plurality of event sequences.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIG. 3 illustrates a system level diagram of an embodiment of a communication system that provides an environment for application of the principles of the present invention;

FIG. 4 illustrates a system level diagram of an embodiment of a communication system including a wireless communication system that provides an environment for application of the principles of the present invention;

FIGS. 5 to 7 illustrate graphical representations of embodiments of methods of operating a communication system in accordance with the principles of the present invention;

FIG. 8 illustrates a system level diagram of an embodiment of a communication element of a communication system constructed in accordance with the principles of the present invention;

FIG. 9 illustrates a block drawing illustrating exemplary processes between user equipment in active and idle modes in communication with a serving base station in accordance with the principles of the present invention; and

FIGS. 10 and 11 illustrate flow diagrams of embodiments of methods of operating a communication system in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of an apparatus, system and method for deriving (e.g., adjusting) network parameters for cell selection/reselection in a communication system. Although the apparatus, system and method are described with reference to a 3GPP UMTS terrestrial radio access (“UTRA”) communication system, they can be applied to any communication system or network including, without limitation, an evolved UMTS terrestrial radio access (“E-UTRA”) communication system and a Global System for Mobile Communications (“GSM”) communication system.

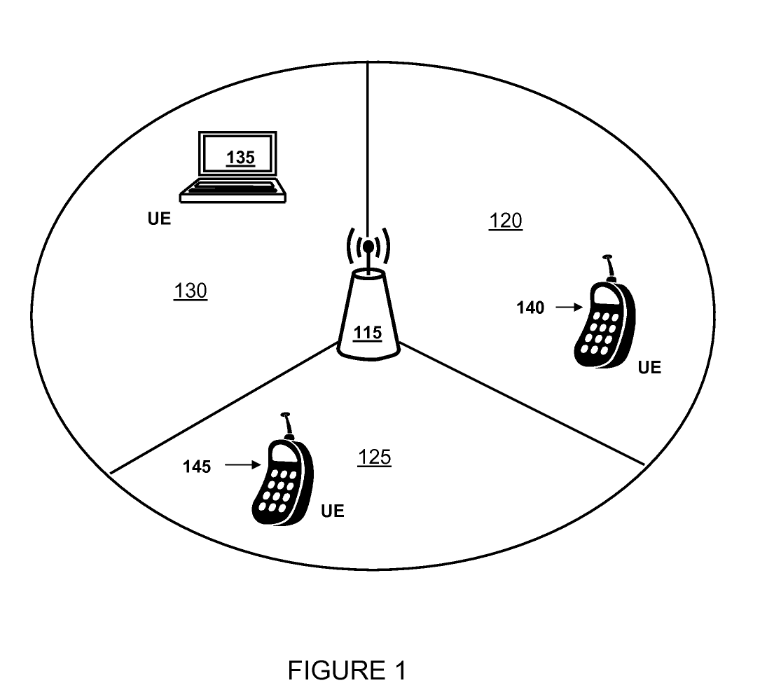

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. Although FIG. 1 illustrates one wireless communication device (e.g., wireless communication device 140) in each sector (e.g., the first sector 120), a sector (e.g., the first sector 120) may generally contain a plurality of wireless communication devices. The sectors (e.g., the first sector 120) are formed by focusing and phasing radiated signals from the base station antennas, and separate antennas may be employed per sector (e.g., the first sector 120). The plurality of sectors 120, 125, 130 increases the number of subscriber stations (e.g., the wireless communication devices 135, 140, 145) that can simultaneously communicate with the base station 115 without the need to increase the utilized bandwidth by reduction of interference that results from focusing and phasing base station antennas.

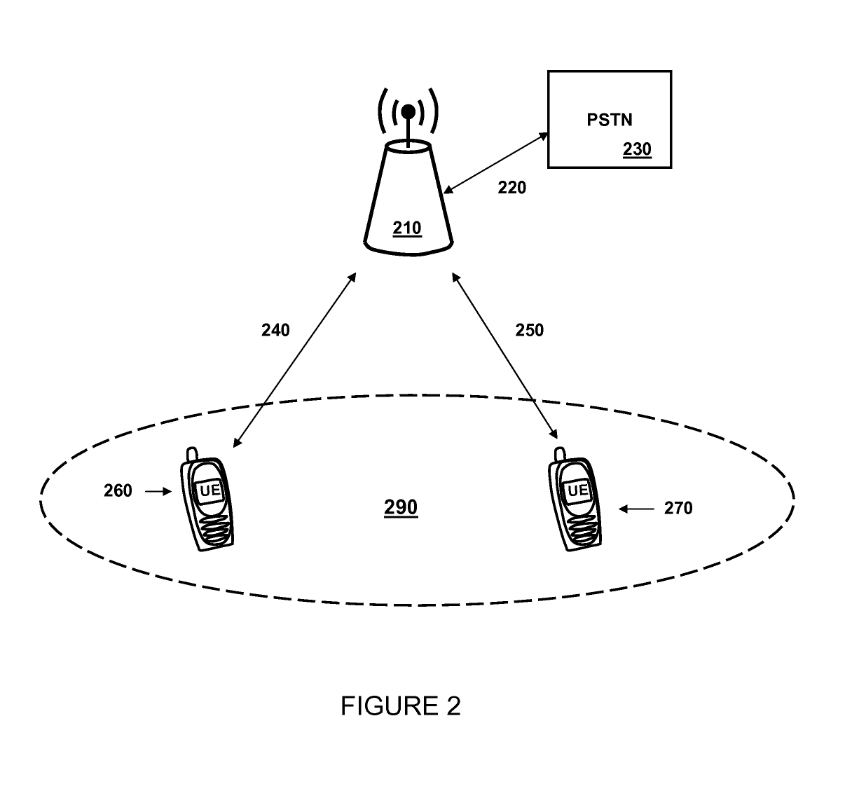

Turning now to FIG. 2, illustrated is a system level diagram of an embodiment of a communication system including wireless communication devices that provides an environment for application of the principles of the present invention. The communication system includes a base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to wireless communication devices 260, 270, respectively, that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes.

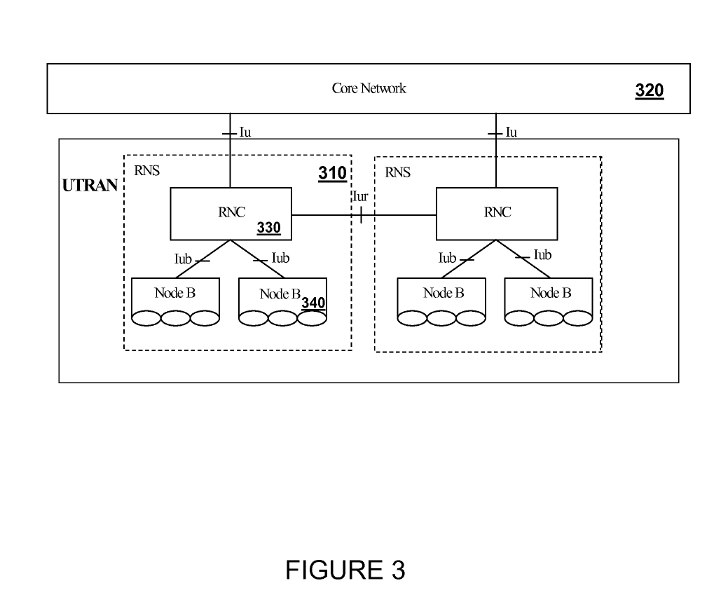

Turning now to FIG. 3, illustrated is a system level diagram of an embodiment of a communication system that provides an environment for application of the principles of the present invention. The communication system may be configured to provide UMTS terrestrial radio access network (“UTRAN”) universal mobile telecommunications services. The communication system includes radio network subsystems (“RNS,” one of which is designated 310) connected to a core network 320 through Iu communication links or paths (ones of which are designated “Iu” interface). The radio network subsystems 310 include at least one radio network controller (“RNC,” one of which is designated 330) connected to at least one base station (a “Node B,” one of which is designated 340) through Iub communication links or paths (ones of which are designated “Iub” interface). The radio network subsystems 310 may also include a stand-alone serving mobile location center (“SAS”). The base stations 340 can support frequency division duplex (“FDD”), time division duplex (“TDD”) or dual mode communication operations.

The radio network controllers 330 are responsible for the handover decisions that require signaling to the user equipment (not shown). The radio network controllers 330 may include a combining/splitting function to support combination/splitting of information streams within the wireless communication system. The radio network controllers 330 can be interconnected through Iur communication links or paths (ones of which are designated “Iur” interface). The Iu, Iub and Iur interfaces are logical interfaces and the Iur interface can be conveyed over a direct physical connection between the radio network controllers 330 or virtual networks using any suitable transport network.

The base stations 340 communicate with the user equipment, which is typically a mobile transceiver carried by a user. Thus, communication links coupling the base stations 340 to the user equipment are air links employing a wireless communication signal such as, for example, a wideband code division multiple access (“WCDMA”) signal. For a better understanding of the communication system described herein, see 3GPP TS 25.401, entitled “Technical Specification Group Radio Access Network; UTRAN overall description,” Release 8, June 2008, which is incorporated herein by reference.

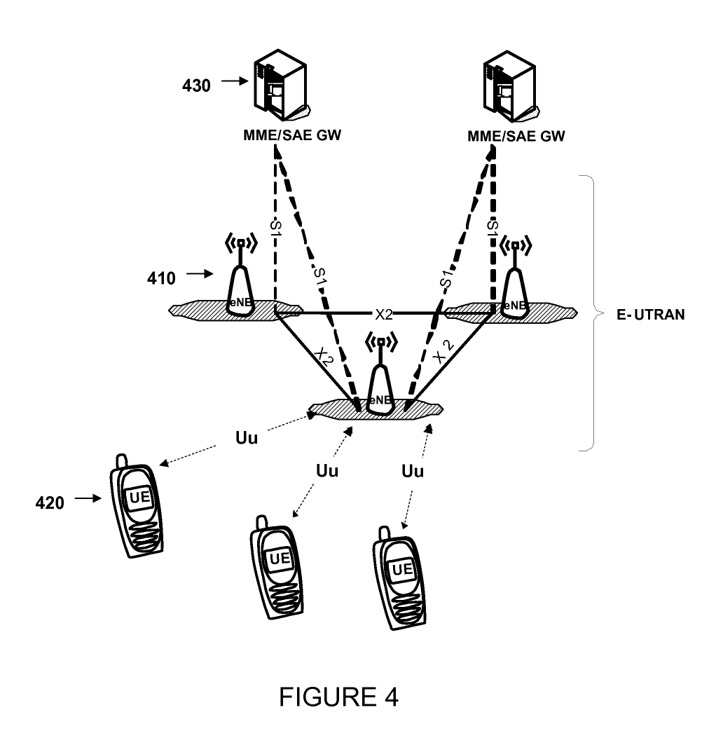

Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (e.g., payload data) and control plane (e.g., radio resource control) protocol terminations towards user equipment (one of which is designated 420). The base stations 410 are interconnected with X2 interfaces or communication links (designated “X2”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as internet protocol (“IP”) header compression and encryption of user signal streams, ciphering of user signal streams, radio bearer control, radio admission control, connection mobility control, dynamic allocation of resources to user equipment in both the uplink and the downlink, selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of user plane packets for paging reasons, switching of user plane for support of the user equipment mobility, idle state mobility control, and system architecture evolution bearer control. The user equipment 420 receives an allocation of a group of information blocks from the base stations 410.

As introduced herein a wireless communication network acquires communication statistics (e.g., network parameters) from user equipment in an active mode to enable the network to automatically adjust parameters related to user equipment actions such as cell selection/reselection in an idle mode. The adjusted parameters are broadcast to the user equipment to enhance user equipment performance, such as performance measured by metrics related to quality of service and user equipment battery life. Exemplary adjusted parameters that can be broadcast by the network to the user equipment relate to cell selection/reselection thresholds or measurement thresholds employed by the user equipment in an idle mode.

In conventional network operation, a network uses manually set thresholds for the user equipment in a broadcast area. The automatic adjustment of parameters enables the network to better accommodate “hotspots” as well as microcells that may not operate continuously. Adjustment of parameters can also be made to accommodate geographical obstructions, urban canyons and rural environments. Thus, a communication system with automated procedures for local self-optimization is produced that avoids the need for continuing human intervention for parameter maintenance. It should be understood that the term “optimization” (and variants thereof) as used herein is not limited to an ideal or theoretically best performance or value, but also encompasses an improved performance or value. Additionally, the term “minimization” (and variants thereof) as used herein is not limited to an ideal or theoretically low performance or value, but also encompasses a lower performance or value.

Enhanced active mode measurements are performed by the user equipment to enable a base station (e.g., a serving base station) of a network to provide parameters related to user equipment coverage and operations, for example, idle mode parameters for cell selection/reselection for the user equipment operable in an idle mode. The active mode measurements are made by the user equipment when an active radio resource control connection has been established. During the idle mode, an active radio resource control connection is not established. The user equipment is adapted to produce an event sequence estimating communication channel performance between the user equipment operable in an active mode emulating an idle mode and a serving base station. The user equipment is configured to select/reselect a target base station employing the idle mode parameters derived from a plurality of event sequences by, for instance, the serving base station. The enhanced active mode measurements performed by the user equipment can be applied to any mobile cellular radio communications systems including, but not limited to, existing and future 3GPP technologies.

The enhanced active mode measurements may be employed with existing active mode event sequences to improve performance of the cell selection/reselection by the user equipment to support self-organizing/optimizing networks and to drive test minimization concepts and use cases. One example of a use case relates to base station coverage management. These functions are described in 3GPP LTE Technical Report 3GPP TR 36.902 and in 3GPP LTE TS 32.521, cited previously above. The self-organizing/optimizing network concept describes “use cases” to support automatic radio access network configuration and optimization. The self-organizing/optimizing network specification, however, does not provide or describe user equipment-related procedures that could provide input to self-organizing/optimizing network such as for drive test minimization procedures, or network responses.

Enhancements are made to active mode user equipment measurement events defined in 3GPP TS 25.331, entitled “Radio Resource Control (RRC); Protocol Specification,” Release 8, June 2009, which is incorporated herein by reference, to relieve these deficiencies. The enhancements are defined to support network self-organizing/optimizing network procedures, and are directed to finding optimal values for idle mode parameters. The enhanced active mode measurement events or event sequences by the user equipment provide user equipment input information to the network to optimize the idle mode parameters.

One exemplary parameter set by the network is the “Sintrasearch” neighboring or target base station measurement threshold. The parameter Sinterasearch provides a quality of service threshold employed by the user equipment in an idle mode to initiate a search for a neighboring or target base station with a higher quality of service. If the quality of service of the presently serving cell is greater than the parameter Sintrasearch, then a search for another base station is not performed by the user equipment operable in the idle mode. Performing a search and measuring channel characteristics of another base station is a process that consumes user equipment battery energy. Accordingly, it is advantageous to avoid an unnecessary search. It should be understood that the term “neighboring base station” may be used interchangeable with the term “target base station” depending on the context of the term.

Another exemplary parameter is the setting for the “Treselection” neighboring or target base station selection/reselection timer, for which a long setting results in the “too late cell selection/reselection problem.” The parameter Treselection refers to a timer threshold employed by the user equipment in idle mode that inhibits handover of the user equipment to a neighboring or target base station based on quality of service measurements made over an interval of time shorter than this parameter. If the parameter Treselection is set too short by a base station, then the user equipment may make needless handovers to a neighboring or target base station based on varying channel measurement data. If the parameter Treselection is set too long by a base station, the quality of service for the user equipment may be adversely affected. Thus, the parameter Treselection provides a mechanism to avoid responding to a temporary fluctuation in channel measurement data (i.e., it enables validation of such data before a base station selection/reselection action is taken by the user equipment in idle mode).

It should be noted that although the examples presented herein apply for simplicity to intrafrequency (i.e., operating on substantially the same carrier frequency) neighboring or target cell measurement events, the processes introduced herein can be applied to other possible types of neighboring or target base stations, for example, neighboring or target base stations operating with different carrier frequencies (“interfrequencies”) and with different radio access technologies (“RATs”) such as GSM, code division multiple access (“CDMA”)-2000, etc.

The 3G technology (e.g., UTRAN) currently does not provide an automated mechanism or process to optimize operation of the user equipment in idle mode in a radio access network. Solutions currently available in 3GPP self-organizing/optimizing networks do not specify a measurement mechanism that could support efficient network configuration and optimization in terms of idle mode parameters. As a result, mobile operators conventionally perform a resource intensive and time consuming drive test to address radio coverage issues and to adjust related network parameters.

It is noted that in the active mode, the association of the user equipment with a particular base station is under direct control of the network, which assists and enables handover of the user equipment to a neighboring or target base station. In the idle mode, the user equipment operates in a more autonomous fashion, because the user equipment lacks a radio resource control connection to the network. Processes performed by the user equipment to identify a neighboring or target base station with a satisfactory quality of service present a drain on the user equipment's battery.

To support future self-organizing/optimizing network procedures that affect the operation of the user equipment in the idle mode, drive test minimization and use cases as defined by 3GGP and the next generation mobile network organization (as described, for example, at www.ngmn.org), there is a need to define new procedures and measurements that could support the same. The current 3GPP state of the art does not provide a process for optimization of idle mode parameters employable by user equipment in the idle mode for selection/reselection of a cell.

The enhancements to existing 3GPP active mode measurement events or event sequences provided by the user equipment are introduced herein based on a process wherein existing active mode event sequences and the associated parameters are mapped to corresponding idle mode parameters. By using these enhancements, the user equipment in an active mode is able to emulate idle mode cell selection/reselection behavior in parallel with ongoing active mode processes. By using the emulated behavior, a base station can extract useful optimization and performance data related to base station selection/reselection parameters employed by the user equipment operating in idle mode. Data extracted from the user equipment in the active mode is used to increase the quality of an idle mode parameters derived by a base station for cell selection/reselection. The data could be immediately reported to and employed by related self-organizing/optimizing network parameters and entities in the network.

Based on, but not limited to, an intrafrequency example, a mapping between corresponding active and idle mode parameters is employed with enhancement to support related idle mode parameter optimization. The enhancement is based on serving and neighboring or target base station common pilot channel (“CPICH”) measurements performed in the user equipment as defined by 3GPP specifications in active and idle modes of operation. Idle mode measurement evaluation time (Tₑᵥₐₗᵤₐₜₑ) can be taken into consideration in the setting of the layer 3 (“L3”) filter coefficient for the active mode. By emulating user equipment idle mode processes in an active mode, two optimization processes are introduced herein for a network such as a self-organizing/optimizing network.

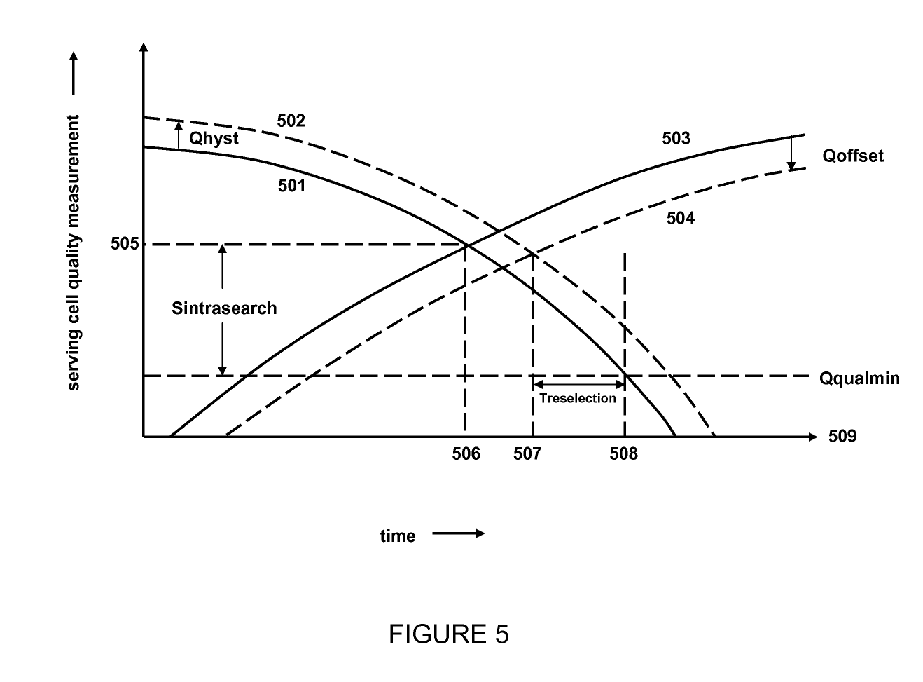

One is a process of optimizing the value of the idle mode intrafrequency neighboring or target base station measurement threshold Sintrasearch. A second is a process of detecting that base station selection/reselection by the user equipment in an idle mode is being performed too late based on an active mode event sequence 1D, 1F, 1D. The event “1D” refers to the user equipment changing to another neighboring or target base station, and the event “1F” refers to the common pilot channel in the serving base station becoming worse than a threshold (such as a threshold “Qqualmin,” described hereinbelow with reference to FIG. 5), thereby adversely limiting communication with the serving base station. The event sequence “1D, 1F, 1D” which includes the event 1F indicates that handover of the user equipment to a neighboring or target base station with a higher quality of service occurred too late. Those processes are based on base station measurements performed during terminal mobility, particularly processes related to handover of the user equipment to a neighboring or target base station when the user equipment is in an idle mode of operation.

Turning now to FIG. 5, illustrated is a graphical representation of an embodiment of a method of operating a communication system in accordance with the principles of the present invention. More specifically, FIG. 5 illustrates a graphical representation of a user equipment idle mode intrafrequency neighboring or target base station selection/reselection procedure depending on idle mode parameters Treselection, Sintrasearch, Qhyst, Qoffset, and Qqualmin provided to the user equipment by the serving base station. The graph illustrates the idle mode parameters as a function of communication channel performance (e.g., channel quality measurements) with the user equipment in a serving base station and in a potential neighboring or target base station versus evolution of time on the horizontal axis. Evolution of time on the horizontal axis represents motion of the user equipment in both the serving base station and the neighboring or target base station. The FIGURE illustrates ideal monotonic channel quality behavior of the base stations.

A curve 501 represents the evolution of the serving base station channel quality measurement (e.g., a signal-to-noise ratio), and a curve 503 represents evolution of a similar measurement for a neighboring or target base station. If the user equipment moves along a path with a uniform communication characteristic, the serving base station quality measurement monotonically decreases, and the corresponding measurement for the neighboring or target base station monotonically increases, representing the ideal behavior. In a typical situation, neither the curve 501 nor the curve 503 is monotonic. A dashed line 505 represents a level at which the channel quality measurement for the neighboring or target base station exceeds that for the serving base station. A time 506 represents the optimal start time for an intrafrequency handover of the user equipment to a neighboring or target base station. A channel quality level represented by a dashed line Qqualmin is the lowest level at which satisfactory communication can be sustained between the user equipment and the serving base station. A channel quality level represented by a line 509 represents the base station signal detection threshold for the user equipment.

A range of channel quality represented by the parameter Sintrasearch, a parameter provided to the user equipment by the serving base station, is the range in which the user equipment in idle mode searches for a neighboring or target base station with better channel quality characteristics. The larger the value for Sintrasearch, the more energy expended by the user equipment in searching for neighboring or target base stations, but the less likely the user equipment will experience a communication outage with the serving base station. Thus, the parameter Sintrasearch may be employed by the network to balance battery utilization by the user equipment against communication outages.

The parameters Qhyst, Qoffset are added to and subtracted from the serving base station and the neighboring or target base station quality measurement, respectively, to generate curves 502, 504 to condition the process for initiating handover of the user equipment to the neighboring or target base station. With conditioning of that process, represented by a time 507, a delay of Treselection is imposed before the actual handover is requested by the user equipment at a time 508 to reduce the number of unnecessary base station selections/reselections and handovers due to short-term signal variations such as those that may be due to man-made or geographic obstructions.

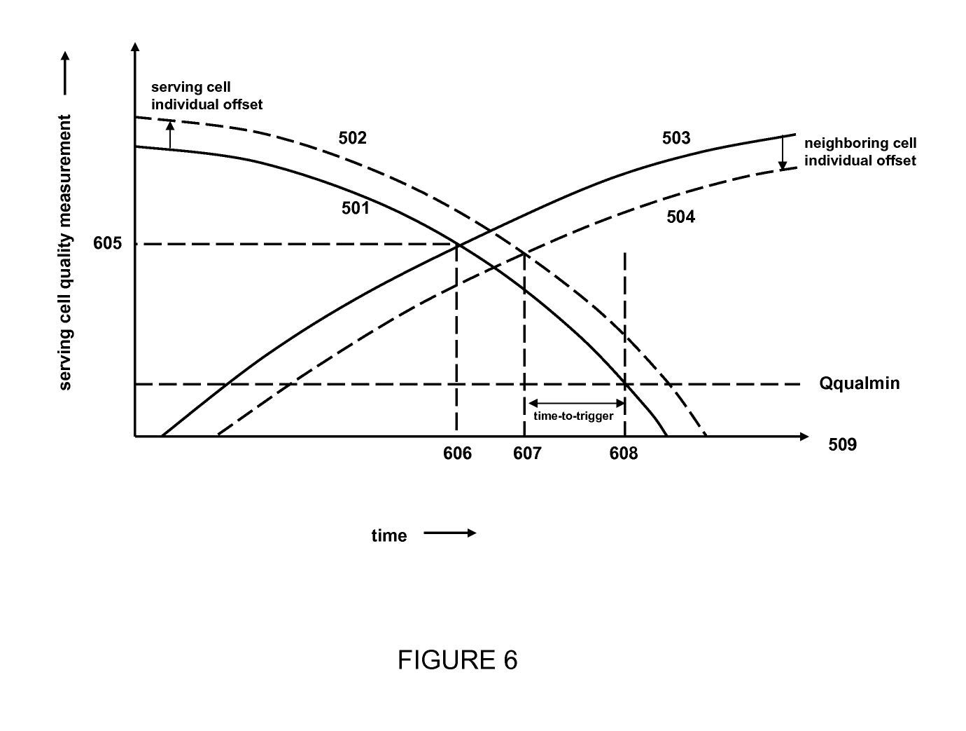

Turning now to FIG. 6, illustrated is a graphical representation of another embodiment of a method of operating a communication system in accordance with the principles of the present invention. FIG. 6 illustrates a graphical representation similar to that illustrated in FIG. 5 of the communication channel performance (e.g., channel quality measurements) with the user equipment in active mode in a serving base station and in a potential neighboring or target base station. FIG. 6 shows an active mode intrafrequency neighboring or target base station selection/reselection procedure performed by the user equipment that is dependent on the commonly used active mode parameters time-to-trigger, serving base station individual communication channel performance offset (also referred to as serving cell individual offset), neighboring or target base station individual communication channel performance offset (also referred to as neighboring or target cell individual offset), and the idle mode parameter Qqualmin. Each of these parameters may be adjusted by the serving base station to represent the changing environment of the serving base station and the neighboring or target base station. Also, for the purposes of clarity, like communication channel performance (or channel measurements) and parameters from FIG. 5 are designated with like reference numbers in the graphical representation illustrated in FIG. 6.

When the measured value of the serving base station quality measurement and that of a neighboring or target base station are equal, the event 1D indicating a change of the base station is reported to the serving base station by the user equipment in the active mode. The user equipment in active mode reports a level 605 of the serving base station quality measurement at a time 606 to the serving base station. The user equipment employs the parameter time-to-trigger=0 (i.e., the user equipment does not wait to report parameters to the network that could enable a handover to a neighboring or target base station). The absence of delay in this process is not intended to remove the signal averaging process applied to obtain a signal-to-noise measurement for a channel characteristic. In addition, the user equipment employs the parameters serving cell individual offset=0, and neighboring or target cell individual offset=0 (i.e., the user equipment does not employ a bias in assessing channel performance for a serving base station and for a neighboring or target base station). When the measurement values of quality, offset by the serving cell individual offset, and offset by the neighboring or target cell individual offset, respectively, are equal at a time 607, a timer interval of duration “time-to-trigger” is initiated by the serving base station. At the end of the time-to-trigger interval, at a time 608, the user equipment is handed over to the neighboring or target base station. If the user equipment had entered idle mode during the interim interval, the serving base station quality measurement value illustrated in FIG. 6 is above the serving base station parameter Qqualmin, indicating that the user equipment can maintain a satisfactory level of communication with the serving base station before actual handover occurs. Thus, the parameter Sintrasearch is sufficiently large for this illustrative case to maintain satisfactory communication between the user equipment and the serving base station, while dissipating only a modest amount of idle mode energy from the user equipment's battery for handover processes.

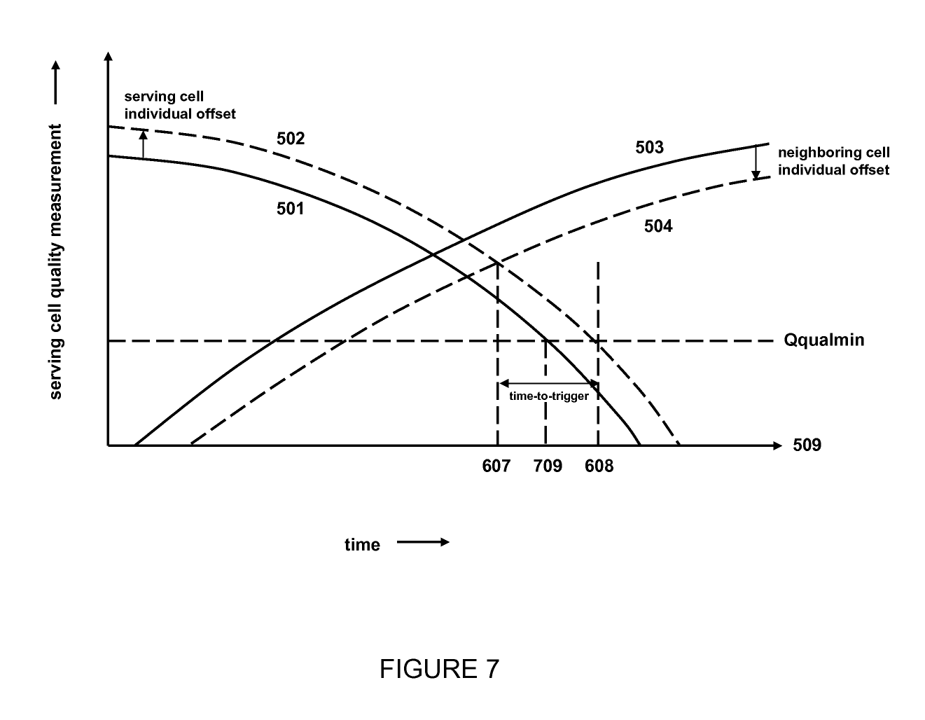

Turning now to FIG. 7, illustrated is a graphical representation of another embodiment of a method of operating a communication system in accordance with the principles of the present invention. FIG. 7 illustrates a graphical representation similar to that illustrated in FIG. 5 of the communication channel performance (e.g., channel quality measurements) with the user equipment in active mode in a serving base station and in a potential neighboring or target base station. FIG. 7 shows an active mode intrafrequency neighboring or target base station selection/reselection scenario procedure at a base station dependent on the active mode parameters time-to-trigger, serving base station individual communication channel performance offset (also referred to as serving cell individual offset), neighboring or target base station individual communication channel performance offset (also referred to as neighboring or target cell individual offset), and the idle mode parameter Qqualmin. Each of these parameters may be adjusted by the serving base station to represent the changing environment of the serving base station and the neighboring or target base station. Also, for the purposes of clarity, like communication channel performance (or channel measurements) and parameters from FIGS. 5 and 6 are designated with like reference numbers in the graphical representation illustrated in FIG. 7.

When the offset measured values of the serving base station and the neighboring or target base station quality measurements are equal at the time 607, the event 1D indicating a change of the base station is reported to the serving base station by the user equipment in active mode. The user equipment in active mode also reports the level of the serving base station quality measurement at this time to the serving base station. The user equipment employs the parameter time-to-trigger=0 (i.e., the user equipment does not wait to report parameters to the network that could enable a handover to a target base station). In addition, the user equipment employs the parameters “serving cell individual offset,” and “neighboring or target cell individual offset” (i.e., the serving base station employs a bias in assessing user equipment channel performance for a serving base station and for a neighboring or target base station). When the reported measurement values of quality, offset by the serving cell individual offset, and the neighboring or target cell individual offset, respectively, are equal at the time 607, a timer interval of duration “time-to-trigger” is initiated by the user equipment. At the end of the time-to-trigger interval, at the time 608, the user equipment is handed over to the neighboring or target base station.

If the user equipment had entered idle mode during the interim interval, in this case the serving base station quality measurement value illustrated in FIG. 7 would fall below the serving base station parameter Qqualmin, indicating that the user equipment cannot sustain satisfactory communication with the serving base station before the actual handover occurs. The serving base station quality measurement value is equal to the serving base station parameter Qqualmin at the time 709. The serving base station quality measurement value falling below the serving base station parameter Qqualmin will be reported to the serving base station by the user equipment as the event 1F, indicating that handover of the user equipment to the neighboring or target base station with a higher quality of service occurred too late. Thus, the parameters “serving cell individual offset,” “neighboring or target cell individual offset,” and Treselection are now not set correctly for this illustrative case to maintain satisfactory communication between the user equipment and the serving base station. The offset parameters for the serving base station quality measurements could be adjusted by the serving base station to provide an improved level of communication performance with the user equipment at the expense of increased battery drain in the user equipment. For example, the serving cell individual offset or Treselection timer may be reduced.

In a first process, as introduced herein, the network generates an improved value of an idle mode parameter such as the idle mode intrafrequency neighboring or target base station measurement threshold Sintrasearch (i.e., the threshold transmitted to and employed by the user equipment in an idle mode to initiate a search for a neighboring or target base station in the same frequency band with a higher quality of service than the presently serving base station). It is assumed that initially the measurement threshold Sintrasearch has not been adjusted by the serving base station. A user equipment measures communication characteristics in both active and idle modes with neighboring or target intracells (i.e., with neighboring or target base stations employing the same carrier frequency). Recall that the user equipment reports communication characteristics with the serving base station and a neighboring or target base station in the active mode.

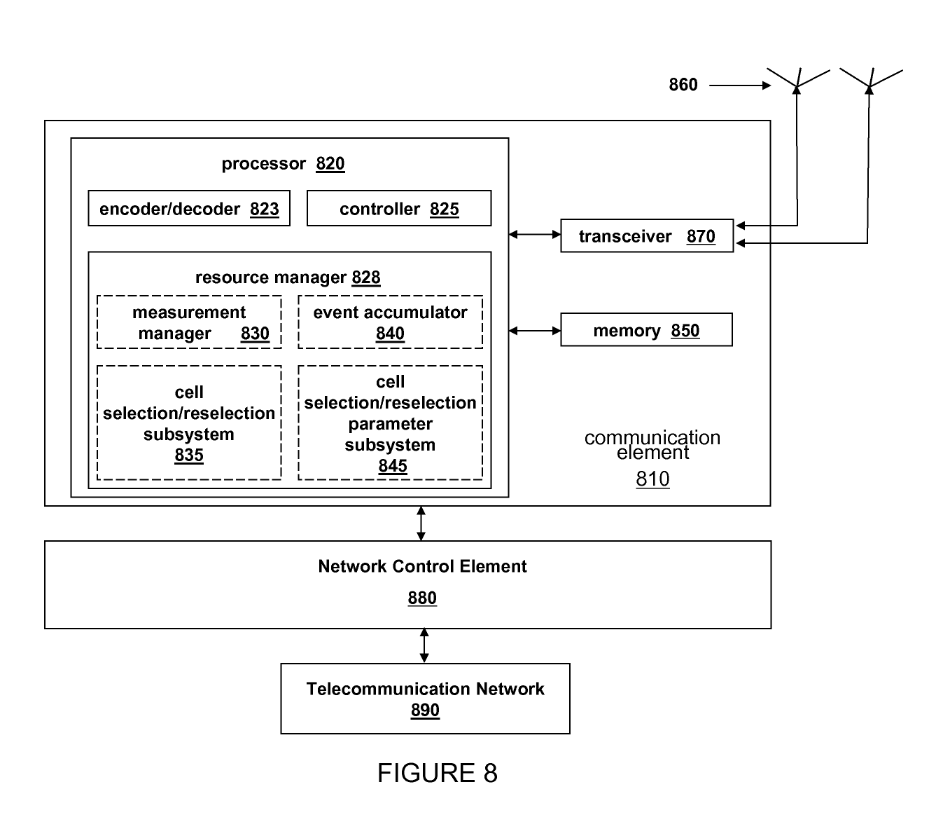

Turning now to FIG. 8, illustrated is a system level diagram of an embodiment of a communication element 810 of a communication system constructed in accordance with the principles of the present invention. The communication element or device 810 may represent, without limitation, a base station, user equipment (e.g., a subscriber station, a terminal, a mobile station, a wireless communication device), a network control element, a communication node, or the like. The communication element 810 includes, at least, a processor 820, memory 850 that stores programs and data of a temporary or more permanent nature, a plurality of antennas (one of which is designated 860), and a radio frequency transceiver 870 coupled to the antennas 860 and the processor 820 for bidirectional wireless communication. The communication element 810 may provide point-to-point and/or point-to-multipoint communication services.

The communication element 810, such as a base station in a cellular network, may be coupled to a communication network element, such as a network control element 880 of a public switched telecommunication network (“PSTN”) 890. The network control element 880 may, in turn, be formed with a processor, memory, and other electronic elements (not shown). The network control element 880 generally provides access to a telecommunication network such as the PSTN 890. Access may be provided using fiber optic, coaxial, twisted pair, microwave communication, or similar link coupled to an appropriate link-terminating element. A communication element 810 formed as user equipment is generally a self-contained device intended to be carried by an end user.

The processor 820 in the communication element 810, which may be implemented with one or a plurality of processing devices, performs functions associated with its operation including, without limitation, encoding and decoding (encoder/decoder 823) of individual bits forming a communication message, formatting of information, and overall control (controller 825) of the communication element 810, including processes related to management of resources represented by resource manager 828. Exemplary functions related to management of resources include, without limitation, hardware installation, traffic management, performance data analysis, tracking of end users and equipment, configuration management, end user administration, management of user equipment, management of tariffs, subscriptions, and billing, accumulation and management of parameters that can be related to communication channel performance and event sequences such as the event sequences 1D, 1F, 1D, and 1D, 1D, and the like.

When the communication element 810 is formed as a user equipment, the resource manager 828 includes a measurement manager 830 configured to provide (e.g., produce) an event sequence estimating communication channel performance between user equipment operable in an active mode emulating an idle mode and at least one of a serving base station and a target base station (e.g., a neighboring base station). The resource manager 828 further includes a cell selection/reselection subsystem 835 configured to select/reselect the target base station (e.g., a neighboring base station) for the user equipment operable in the idle mode employing an idle mode parameter derived from a plurality of event sequences at the serving base station.

When the communication element 810 is formed as a base station, the resource manager 828 includes an event accumulator 840 configured to receive a plurality of event sequences estimating communication channel performance (e.g., channel quality measurements) from a plurality of user equipment operable in an active mode emulating an idle mode with at least one of a serving base station and a target base station (e.g., a neighboring base station). The resource manager 828 further includes a cell selection/reselection parameter subsystem 845 configured to derive an idle mode parameter for cell selection/reselection by the plurality of user equipment operable in the idle mode as a function of the plurality of event sequences.

In accordance with the foregoing, the communication channel performance may include relative or absolute estimates of one of a power and a quality of said communication channel. Regarding the event sequence, an element thereof may represent that the communication channel performance for the serving base station is equal to or less than a communication channel performance for the target base station (e.g., a 1D event). Also, an element of the event sequence may represent that the communication channel performance for the serving base station is less than a threshold (e.g., a 1F event), or an element of the event sequence may represent that the communication channel performance of a primary common pilot channel between the user equipment and the serving base station is less than a threshold (e.g., a 1F event). The event sequence may be a 1D, 1F, 1D event sequence or a 1D, 1D event sequence.

In accordance with the foregoing, one of the plurality of event sequences may include an element described by an active mode parameter such as a time-to-trigger event of a target base station, a serving base station individual communication channel performance offset for the user equipment, and a target base station individual communication channel performance offset for the user equipment. Additionally, the idle mode parameters may include a Treselection associated with a selection/reselection timer of the target base station, a Sintrasearch, Snonintrasearch, Sintersearch, and S_{searchRAT} associated with a measurement starting threshold or a range of the communication channel performance between the user equipment and the serving base station, a Qhyst associated with communication channel performance offset between the user equipment and the serving base station, a Qoffset associated with communication channel performance offset between the user equipment and the target base station, and a Qqualmin, Qrxlevmin associated with a minimum communication channel performance threshold between the user equipment and the serving base station.

The execution of all or portions of particular functions or processes related to management of resources may be performed in equipment separate from and/or coupled to the communication element 810, with the results of such functions or processes communicated for execution to the communication element 810. The processor 820 of the communication element 810 may be of any type suitable to the local application environment, and may include one or more of general-purpose computers, special purpose computers, microprocessors, digital signal processors (“DSPs”), and processors based on a multi-core processor architecture, as non-limiting examples.

The transceiver 870 of the communication element 810 modulates information onto a carrier waveform for transmission by the communication element 810 via the antennas 860 to another communication element. The transceiver 870 demodulates information received via the antennas 860 for further processing by other communication elements. The transceiver 870 is capable of supporting duplex operation for the communication element 810.

The memory 850 of the communication element 810, as introduced above, may be of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 850 may include program instructions that, when executed by an associated processor, enable the communication element 810 to perform tasks as described herein. Of course, the memory 850 may form a data buffer for data transmitted to and from the communication element 810. Exemplary embodiments of the system, subsystems, and modules as described herein may be implemented, at least in part, by computer software executable by processors of, for instance, the user equipment and the base station, or by hardware, or by combinations thereof. As will become more apparent, systems, subsystems and modules may be embodied in the communication element 810 as illustrated and described herein.

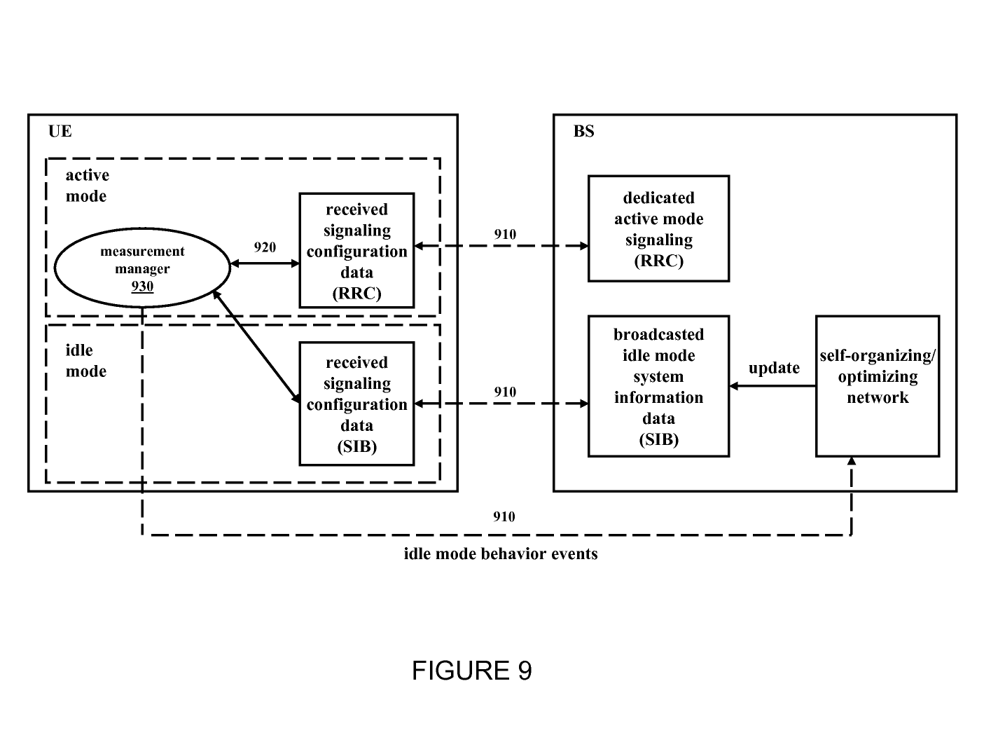

Turning now to FIG. 9, illustrated is a block drawing illustrating exemplary processes between user equipment (designated “UE”) in active and idle modes in communication with a serving base station (designated “BS”) in accordance with the principles of the present invention. The wireless signal paths between the user equipment and the serving base station are again indicated by the dashed lines 910. Internal communication paths within the user equipment and the serving base station are indicated by solid lines such as the line 920. In the active mode, the user equipment receives dedicated signaling configuration data from the serving base station in a radio resource control configuration. The user equipment employs the data in the active mode in a measurement manager 930 and emulates an idle mode behavior. In the idle mode, the user equipment receives dedicated signaling configuration data from the serving base station in a system information broadcast (“SIB”). The data are also transferred to the measurement manager 930. The measurement manager 930 initiates transmission of event sequences such as 1D, 1F, 1D and 1D, 1D event sequences to the serving base station to enable the serving base station to adjust the idle mode parameters in the form of, without limitation, a self-organizing/optimizing network as mentioned above.

The processes described above can be employed as another 3GPP LTE use case for the self-organizing/optimizing network to enable an operator, without any additional effort (e.g., drive testing), to receive useful information from the user equipment from a network configuration point of view. A similar use case can be applied to inter-frequency and inter-RAT base stations. By introducing these processes to optimize idle mode parameters, a self-organizing/optimizing network concept can be efficiently supported by an operator, including a 3GPP drive test minimization use case. The self-organizing/optimizing network concept can be implemented in a communication system with minimal modifications to the user equipment and the base stations.

The processes introduced herein can be implemented to trade-off communication performance with user equipment battery consumption and user equipment complexity in idle mode as they relate to base station site selection/reselection, recognizing that neighboring or target base station measurements nonetheless are performed during an active mode handover procedure. New data (e.g., event sequences) related to idle mode parameters are reported by the user equipment to the network (e.g., the serving base station) using an existing radio resource control connection. Thus, processes as described hereinabove analyze the performance of an idle mode parameter selection/reselection criteria to extract optimization information that can be reported by the user equipment for inclusion in radio network optimization procedures.

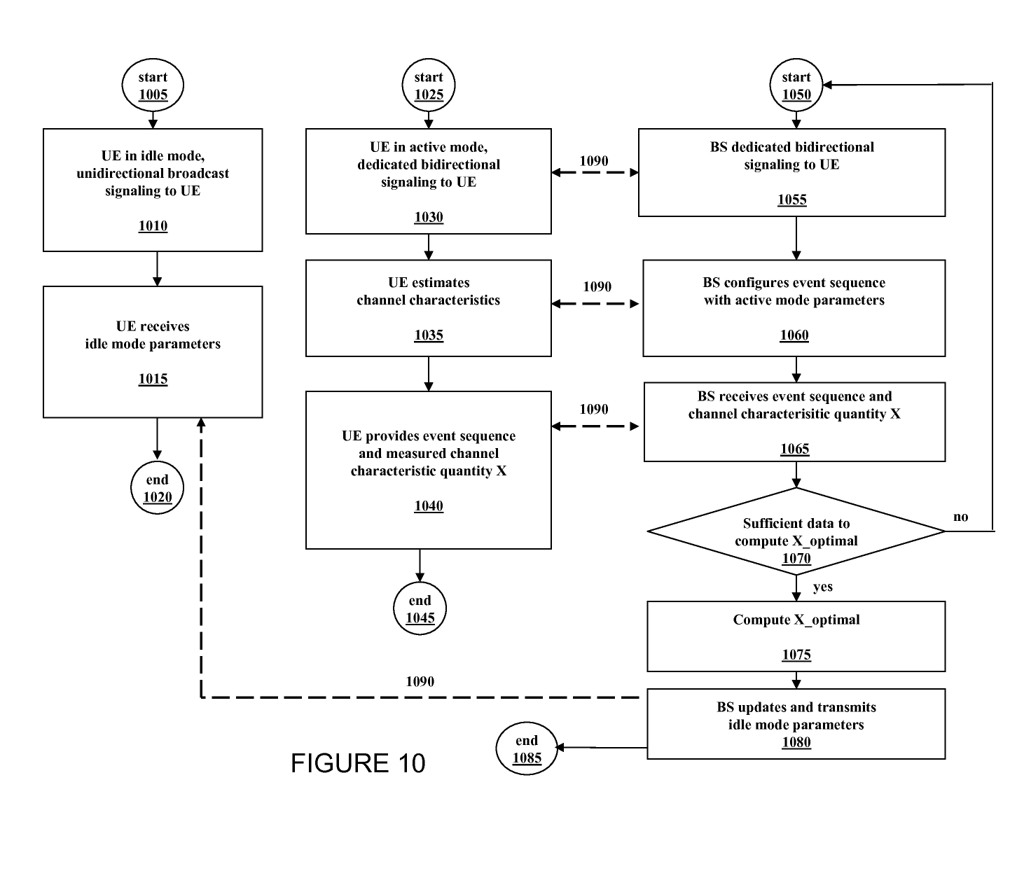

Turning now to FIG. 10, illustrated is a flow diagram of an embodiment of a method of operating a communication system in accordance with the principles of the present invention. FIG. 10 illustrates a process employed to generate an improved value of an idle mode parameter such as the idle mode intrafrequency neighboring or target base station measurement threshold Sintrasearch. A first sequence illustrates a process beginning at a module 1005 at the user equipment in an idle mode. In a module 1010, the user equipment (designated “UE”) is in idle mode and a dedicated radio connection with a serving base station has not been established, thereby allowing for a unidirectional broadcast signaling from the network (via serving base station) to the user equipment. In a module 1015, the user equipment receives from the serving base station the broadcasted idle mode parameters employable for the cell selection/reselection in the user equipment, and applies the idle mode parameters such as Sintrasearch, Treselection, Qhyst, and Qoffset via, for instance, a cell selection/reselection subsystem of a processor thereof. The first sequence ends at a module 1020. Wireless communication paths between the user equipment and a serving base station are indicated by dashed lines 1090.

A second sequence illustrates a process beginning at module 1025 at the user equipment in an active mode. In a module 1030, the user equipment is in the active mode and a dedicated radio connection with a serving base station is established, thereby allowing for dedicated bidirectional signaling with the network (via the serving base station). In a module 1035, the user equipment is in active mode and estimates communication channel performance (e.g. a channel characteristic) performance between the user equipment emulating an idle mode and the serving base station and a target base station(s) via, for instance, a measurement manager of a processor thereof. In a module 1040, when an event sequence 1D is triggered in the user equipment, the user equipment (e.g., in accordance with measurement manager) provides the event sequence and a measured channel characteristic quantity “X” to the serving base station via, for instance, dedicated signaling in the form of a measurement report message. Exemplary channel characteristic quantities X include, without limitation, a channel quality indicator such as signal-to-noise ratio for a pilot signal (“EcNo”) and a power indicator such as receiver signal code power (“RSCP”). The second sequence ends at a module 1045.

A third sequence illustrates a process beginning at module 1050 at a serving base station (designated “BS”) with an active mode connection to the user equipment. In a module 1055, a bidirectional, dedicated radio connection is established to the user equipment with dedicated signaling. In a module 1060, the serving base station employs dedicated radio resource signaling to configure the event sequence 1D for the user equipment with the following active mode parameters, namely, time-to-trigger=0, serving cell individual offset=0, and neighboring or target cell individual offset=0. The value time-to-trigger=0 indicates that the user equipment does not wait to report event sequences to the network that could enable a handover to a neighboring or target base station. Again, the absence of delay in this process is not intended to remove the signal averaging process applied to obtain a signal-to-noise measurement for a channel characteristic. The last two active mode parameters indicate that the network does not employ a bias in assessing channel characteristics for a serving base station and for a neighboring or target base station. When the user equipment is in an active mode, the user equipment initiates the event sequence 1D based on its measurement of the channel characteristics for the serving base station and the neighboring or target base station using the threshold levels supplied by the network. A measurement report message may be employed by the serving base station to communicate these parameters.

In a module 1065, the serving base station receives the event sequence and the channel characteristic quantity X via, for instance, an event accumulator of a processor thereof, stores the same in a database associated therewith. In a module 1070, the serving base station checks to see if enough new data is now in the database to compute an improved channel characteristic quantity value, “X_optimal.” If sufficient new data is not available, the third sequence begins again.

If sufficient new data is now available (in a module 1075), the serving base station based on averaging or statistical processing of the channel characteristic quantity X from a plurality of user equipment provides an improved channel characteristic quantity value X_optimal. In a module 1080, the serving base station (e.g., in accordance with a cell selection/reselection parameter subsystem of a processor thereof) then derives (e.g., updates) an idle mode parameter such as Sintrasearch measurement threshold based on the received value Sintrasearch=X_optimal, and transmits the updated idle mode parameter to the user equipment. The third sequence ends at a module 1085. Thus, the serving base station adjusts the parameter Sintrasearch to a statistically computed value to optimize the user equipments' collective battery performance in a serving area thereof when the user equipment is in an idle mode. The parameter Sintrasearch is statistically computed recognizing that some user equipment are substantially physically stationary, and others are leaving the serving area by various routes and means of transportation. For instance, the parameter Sintrasearch=X_optimal may statistically computed by ordering the channel characteristic quantity X from a statistically significant number of user equipment and selecting the value X_optimal according to the 9^{th} decile of the distribution.

As introduced herein, the serving base station may generate an improved value of the idle mode parameter such as Treselection based on an event sequence 1D, 1F, 1D. Recall that the parameter Treselection refers to the timer threshold employed by the user equipment in idle mode to inhibit handover of the user equipment to a neighboring or target base station based on quality of service measurements made over an interval of time shorter than the threshold.

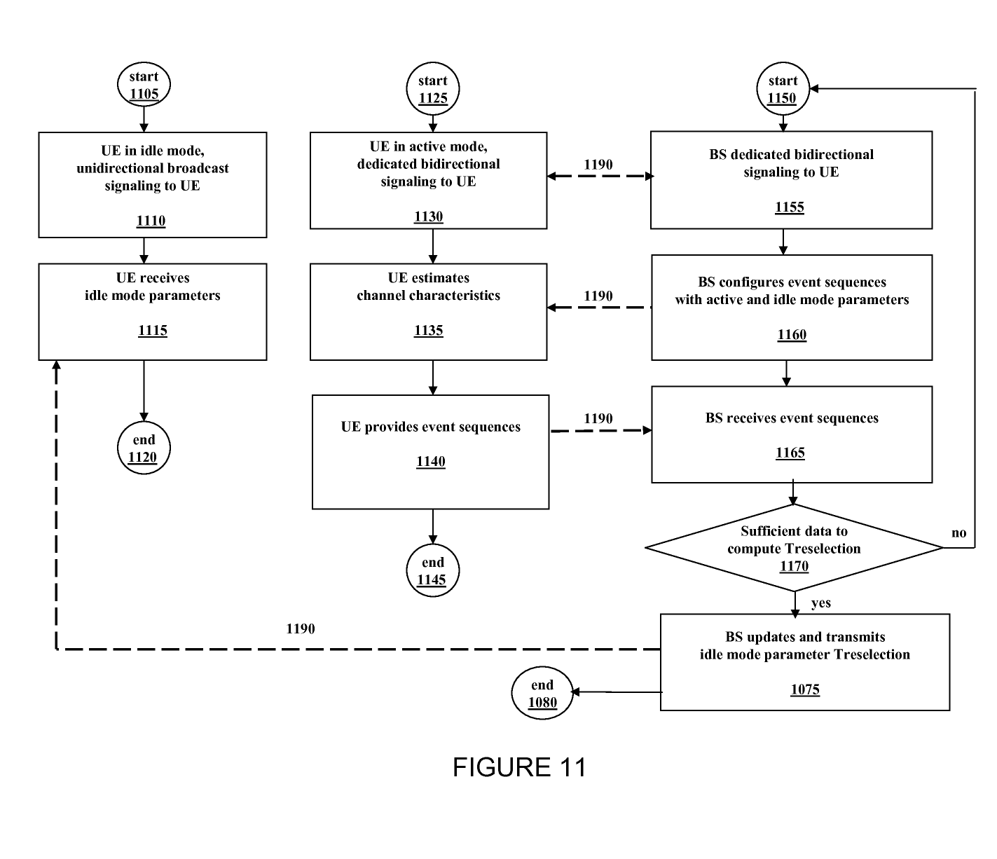

Turning now to FIG. 11, illustrated is a flow diagram of an embodiment of a method of operating a communication system in accordance with the principles of the present invention. A first sequence illustrates a process beginning at a module 1105 at the user equipment in an idle mode. In a module 1110, the user equipment (designated “UE”) is in idle mode and a dedicated radio connection with a serving base station has not been established, thereby allowing for a unidirectional broadcast signaling from the network (via serving base station) to the user equipment. In a module 1115, the user equipment receives from the serving base station the broadcasted idle mode parameters employable for the cell selection/reselection in the user equipment, and applies the idle mode parameters such as Sintrasearch, Treselection, Qhyst, and Qoffset via, for instance, a cell selection/reselection subsystem of a processor thereof. The first sequence ends at a module 1120. Wireless communication paths between the user equipment and a serving base station are indicated by dashed lines 1190.

A second sequence illustrates a process beginning at module 1125 at the user equipment in an active mode. In a module 1130, the user equipment is in the active mode and a dedicated radio connection with a serving base station is established, thereby allowing for dedicated bidirectional signaling with the network (via the serving base station). In a module 1135, the user equipment is in active mode and estimates communication channel performance (e.g., a channel characteristic) performance between the user equipment emulating an idle mode and the serving base station and a target base station(s) via, for instance, a measurement manager of a processor thereof. In a module 1140, when an event sequence is triggered in the user equipment, the user equipment (e.g., in accordance with measurement manager) provides the event sequence to the serving base station. For instance, when the event sequence 1D, 1F, 1D is triggered in the user equipment, the user equipment provides the event sequence to the serving base station indicating that the idle mode parameter Treselection timer is set too long. When the event sequence 1D, 1D is triggered in the user equipment, the user equipment provides the event sequence to the serving base station indicating that the idle mode parameter Treselection timer is set satisfactorily. Dedicated signaling such as a measurement report message may be employed by the user equipment in active mode to transmit the event sequence. The second sequence ends at a module 1145.

A third sequence illustrates a process beginning at module 1150 at a serving base station (designated “BS”) with an active mode connection to the user equipment. In a module 1155, a bidirectional, dedicated radio connection is established to the user equipment with dedicated signaling. In a module 1160, the serving base station employs dedicated radio resource signaling to configure the event sequences with the following active and idle mode parameters:
Event 1D: ttt=0, scio=Qhyst, ncio=Qoffset (wherein, “ttt”=“time to trigger,” “scio”=“serving cell individual offset,” and “ncio”=“neighboring or target cell individual offset”);
Event 1F: ttt=0, at =Qqualmin (“at”=“absolute threshold”); and
Event 1D: ttt=Treselection, scio=Qhyst, ncio=Qoffset.
   It should be understood that the parameters such as time to trigger may be configured in accordance with an event sequence such as 1D to emulate the idle mode behavior.

In a module 1065, the serving base station receives the event sequences via, for instance, an event accumulator of a processor thereof, and stores the same in a database associated therewith. Two counters are maintained in the database. One counter, “1D1F1D_counter,” accumulates the number of 1D, 1F, 1D event sequences provided by the user equipment, and another counter, “1D1D_counter,” similarly accumulates the number of 1D, 1D event sequences. These counters are respectively incremented accordingly:

1D1F1D_counter←1D1F1D_counter+1, and

1D1D_counter←1D1D_counter+1.

In a module 1070, the serving base station checks to see if enough new data is now in the database to derive (e.g., compute) a new value for an idle mode parameter such as Treselection (e.g., in accordance with a cell selection/reselection parameter subsystem of a processor of the base station), which may be determined by threshold levels for the 1D1F1D_counter and the 1D1D_counter. If sufficient new data is not available, the third sequence begins again.

If sufficient new data is now available (in a module 1170), the serving base station indicates that the parameters in the database are based on a ratio of too late selections/reselections to the total number of selections/reselections. For example, the Treselection timer in the serving base station may be adjusted as follows:

Treselection←Treselection−α·(R−R_nominal),

wherein α is a constant such as 0.01, R is the ratio of late selections/reselections to the total number of selections/reselections. In other words,

R=1D1F1D_counter/(1D1F1D_counter+1D1D_counter),

and R_nominal is a nominal value for this ratio, such as the nominal value 0.01. The ratio from a plurality of user equipment is employed to adjust the Treselection timer in the serving base station. After the Treselection timer is adjusted, the counters are reset, and the serving base station provides the idle mode parameter Treselection to the user equipment. The third sequence ends at a module 1180.

Program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus, comprising:
a measurement manager configured to provide an event sequence estimating communication channel performance between a user equipment operable in an active mode emulating an idle mode and at least one of a serving base station and a target base station; and
a cell selection/reselection subsystem configured to select/reselect said target base station for said user equipment operable in said idle mode employing an idle mode parameter derived from a plurality of event sequences at said serving base station.

2. The apparatus as recited in claim 1 wherein said communication channel performance comprises relative or absolute estimates of one of a power and a quality of said communication channel.

3. The apparatus as recited in claim 1 wherein an element of said event sequence represents that said communication channel performance for said serving base station is equal to or less than said communication channel performance for said target base station.

4. The apparatus as recited in claim 1 wherein an element of said event sequence represents that said communication channel performance for said serving base station is less than a threshold.

5. The apparatus as recited in claim 1 wherein an element of said event sequence represents that said communication channel performance of a primary common pilot channel between said user equipment and said serving base station is less than a threshold.

6. The apparatus as recited in claim 1 wherein said event sequence is selected from the group consisting of:
a 1D, 1F, 1D event sequence, and
a 1D, 1D event sequence.

7. The apparatus as recited in claim 1 wherein said event sequence comprises an element described by an active mode parameter selected from the group consisting of:
time-to-trigger event of said target base station,
serving base station individual communication channel performance offset for said user equipment, and
target base station individual communication channel performance offset for said user equipment.

8. The apparatus as recited in claim 1 wherein said idle mode parameter is selected from the group consisting of:
Treselection associated with a selection/reselection timer of said target base station,
Sintrasearch, Snonintrasearch, Sintersearch and S_{searchRAT} associated with a measurement starting threshold or range of said communication channel performance between said user equipment and said serving base station,
Qhyst associated with communication channel performance offset between said user equipment and said serving base station,
Qoffset associated with communication channel performance offset between said user equipment and said target base station, and
Qqualmin, Qrxlevmin associated with a minimum communication channel performance threshold between said user equipment and said serving base station.

9. A computer program product comprising a program code stored in a computer readable medium configured to provide an event sequence estimating communication channel performance between a user equipment operable in an active mode emulating an idle mode and at least one of a serving base station and a target base station, and select/reselect said target base station for said user equipment operable in said idle mode employing an idle mode parameter derived from a plurality of event sequences at said serving base station.

10. The computer program product as recited in claim 9 wherein said communication channel performance comprises relative or absolute estimates of one of a power and a quality of said communication channel.

11. A method, comprising:
providing an event sequence estimating communication channel performance between a user equipment operable in an active mode emulating an idle mode and at least one of a serving base station and a target base station; and
selecting/reselecting said target base station for said user equipment operable in said idle mode employing an idle mode parameter derived from a plurality of event sequences at said serving base station.

12. The method as recited in claim 11 wherein said communication channel performance comprises relative or absolute estimates of one of a power and a quality of said communication channel.

13. The method as recited in claim 11 wherein an element of said event sequence represents that said communication channel performance for said serving base station is equal to or less than said communication channel performance for said target base station.

14. The method as recited in claim 11 wherein an element of said event sequence represents that said communication channel performance for said serving base station is less than a threshold.

15. The method as recited in claim 11 wherein an element of said event sequence represents that said communication channel performance of a primary common pilot channel between said user equipment and said serving base station is less than a threshold.

16. An apparatus, comprising:
an event accumulator configured to receive a plurality of event sequences estimating communication channel performance from a plurality of user equipment operable in an active mode emulating an idle mode with at least one of a serving base station and a target base station; and
a cell selection/reselection parameter subsystem configured to derive an idle mode parameter for cell selection/reselection by said plurality of user equipment operable in said idle mode as a function of said plurality of event sequences.

17. The apparatus as recited in claim 16 wherein said communication channel performance comprises relative or absolute estimates of one of a power and a quality of said communication channel.

18. The apparatus as recited in claim 16 wherein an element of one of said plurality of event sequences represents that said communication channel performance between one of said plurality of user equipment and said serving base station is equal to or less than said communication channel performance between said one of said plurality of user equipment and said target base station.

19. The apparatus as recited in claim 16 wherein an element of one of said plurality of event sequences represents that said communication channel performance between one of said plurality of user equipment and said serving base station is less than a threshold.

20. The apparatus as recited in claim 16 wherein an element of one of said plurality of event sequences represents that said communication channel performance of a primary common pilot channel between one of said plurality of user equipment and said serving base station is less than a threshold.

21. The apparatus as recited in claim 16 wherein one of said plurality of event sequences is selected from the group consisting of:
a 1D, 1F, 1D event sequence, and
a 1D, 1D event sequence.

22. The apparatus as recited in claim 16 wherein one of said plurality of event sequences comprises an element described by an active mode parameter selected from the group consisting of:
time-to-trigger event of said target base station,
serving base station individual communication channel performance offset for said user equipment, and
target base station individual communication channel performance offset for said user equipment.

23. The apparatus as recited in claim 16 wherein said idle mode parameter is selected from the group consisting of:
Treselection associated with a selection/reselection timer of said target base station,
Sintrasearch, Snonintrasearch, Sintersearch and S_{searchRAT} associated with a measurement starting threshold or a range of said communication channel performance between said user equipment and said serving base station,
Qhyst associated with communication channel performance offset between said user equipment and said serving base station,
Qoffset associated with communication channel performance offset between said user equipment and said target base station, and
Qqualmin, Qrxlevmin associated with a minimum communication channel performance threshold between said user equipment and said serving base station.

24. A computer program product comprising a program code stored in a computer readable medium configured to receive a plurality of event sequences estimating communication channel performance from a plurality of user equipment operable in an active mode emulating an idle mode with at least one of a serving base station and a target base station; and
a cell selection/reselection parameter subsystem configured to derive an idle mode parameter for cell selection/reselection by said plurality of user equipment operable in said idle mode as a function of said plurality of event sequences.

25. The computer program product as recited in claim 24 wherein said communication channel performance comprises relative or absolute estimates of one of a power a quality of said communication channel.

26. A method, comprising:
receiving a plurality of event sequences estimating communication channel performance from a plurality of user equipment operable in an active mode emulating an idle mode with at least one of a serving base station and a target base station; and
deriving an idle mode parameter for cell selection/reselection by said plurality of user equipment operable in said idle mode as a function of said plurality of event sequences.

27. The method as recited in claim 26 wherein said communication channel performance comprises relative or absolute estimates of one of a power and a quality of said communication channel.

28. The method as recited in claim 26 wherein an element of one of said plurality of event sequences represents that said communication channel performance between one of said plurality of user equipment and said serving base station is equal to or less than said communication channel performance between said one of said plurality of user equipment and said target base station.

29. The method as recited in claim 26 wherein an element of one of said plurality of event sequences represents that said communication channel performance between one of said plurality of user equipment and said serving base station is less than a threshold.

30. The method as recited in claim 26 wherein an element of one of said plurality of event sequences represents that said communication channel performance of a primary common pilot channel between one of said plurality of user equipment and said serving base station is less than a threshold.
